(19) United States
(12) Patent Application Publication
(10) Pub. No.: US 2022/0292339 A1
(43) Pub. Date: Sep. 15, 2022

(54) MACHINE LEARNING TECHNIQUES FOR PREDICTIVE CONFORMANCE DETERMINATION

(71) Applicant: Optum Services (Ireland) Limited, Dublin (IE)

(72) Inventors: Neill Michael Byrne, Dublin (IE); Michael J. McCarthy, Castleknock (IE); Kieran O'Donoghue, Dublin (IE)

(21) Appl. No.: 17/196,543

(22) Filed: Mar. 9, 2021

(51) Int. Cl. G06N 3/08; G06N 3/04

(52) U.S. Cl. CPC G06N 3/08; G06N 3/0445; G06N 3/0454

(57) ABSTRACT

Various embodiments of the present invention provide methods, apparatus, systems, computing devices, computing entities, and/or the like for performing risk score generation predictive data analysis. Certain embodiments of the present invention utilize systems, methods, and computer program products that perform risk conformance mining predictive data analysis by utilizing machine learning frameworks that include state processing machine learning models and attribute processing machine learning models, where the machine learning frameworks may be trained as part of generative adversarial machine learning frameworks.

### BACKGROUND

Various embodiments of the present invention address technical challenges related to performing predictive data analysis and provide solutions to address the efficiency and reliability shortcomings of existing predictive data analysis solutions.

### BRIEF SUMMARY

In general, various embodiments of the present invention provide methods, apparatus, systems, computing devices, computing entities, and/or the like for performing risk score generation predictive data analysis. Certain embodiments of the present invention utilize systems, methods, and computer program products that perform risk conformance mining predictive data analysis by utilizing machine learning frameworks that include state processing machine learning models and attribute processing machine learning models, where the machine learning frameworks may be trained as part of generative adversarial machine learning frameworks.

In accordance with one aspect, a method is provided. In one embodiment, the method comprises: for each event encoding data object in an ordered sequence of event encoding data objects, generating, using machine learning framework, a state-level attention weight value and an attribute-level attention weight vector based at least in part on the ordered sequence of event encoding data objects, wherein: the machine learning framework comprises a state processing recurrent neural network machine learning model and an attribute processing machine learning model, the state processing recurrent neural network machine learning model is configured to the state-level attention weight value for the event encoding data object based at least in part on each event encoding data object, and the attribute processing machine learning model is configured to generate the attribute-level attention weight vector for the event encoding data object based at least in part on each event encoding data object; generating the conformance score based at least in part on: (i) each state-level attention weight value for a current subset of the ordered sequence that comprises the current event encoding data object and each event encoding data object that has a lower position value relative to the current event encoding data object in accordance with the ordered sequence, and (ii) each attribute-level attention weight vector for the current subset; and performing one or more prediction-based actions based at least in part on the conformance score.

In accordance with another aspect, a computer program product is provided. The computer program product may comprise at least one computer-readable storage medium having computer-readable program code portions stored therein, the computer-readable program code portions comprising executable portions configured to: for each event encoding data object in an ordered sequence of event encoding data objects, generate, using machine learning framework, a state-level attention weight value and an attribute-level attention weight vector based at least in part on the ordered sequence of event encoding data objects, wherein: the machine learning framework comprises a state processing recurrent neural network machine learning model and an attribute processing machine learning model, the state processing recurrent neural network machine learning model is configured to the state-level attention weight value for the event encoding data object based at least in part on each event encoding data object, and the attribute processing machine learning model is configured to generate the attribute-level attention weight vector for the event encoding data object based at least in part on each event encoding data object; generate the conformance score based at least in part on: (i) each state-level attention weight value for a current subset of the ordered sequence that comprises the current event encoding data object and each event encoding data object that has a lower position value relative to the current event encoding data object in accordance with the ordered sequence, and (ii) each attribute-level attention weight vector for the current subset; and perform one or more prediction-based actions based at least in part on the conformance score.

In accordance with yet another aspect, an apparatus comprising at least one processor and at least one memory including computer program code is provided. In one embodiment, the at least one memory and the computer program code may be configured to, with the processor, cause the apparatus to: for each event encoding data object in an ordered sequence of event encoding data objects, generate, using machine learning framework, a state-level attention weight value and an attribute-level attention weight vector based at least in part on the ordered sequence of event encoding data objects, wherein: the machine learning framework comprises a state processing recurrent neural network machine learning model and an attribute processing machine learning model, the state processing recurrent neural network machine learning model is configured to the state-level attention weight value for the event encoding data object based at least in part on each event encoding data object, and the attribute processing machine learning model is configured to generate the attribute-level attention weight vector for the event encoding data object based at least in part on each event encoding data object; generate the conformance score based at least in part on: (i) each state-level attention weight value for a current subset of the ordered sequence that comprises the current event encoding data object and each event encoding data object that has a lower position value relative to the current event encoding data object in accordance with the ordered sequence, and (ii) each attribute-level attention weight vector for the current subset; and perform one or more prediction-based actions based at least in part on the conformance score.

### BRIEF DESCRIPTION OF THE DRAWINGS

Having thus described the invention in general terms, reference will now be made to the accompanying drawings, which are not necessarily drawn to scale, and wherein:

FIG. 1 provides an exemplary overview of an architecture that can be used to practice embodiments of the present invention.

FIG. 2 provides an example predictive data analysis computing entity in accordance with some embodiments discussed herein.

FIG. 3 provides an example client computing entity in accordance with some embodiments discussed herein.

FIG. 4 is a flowchart diagram of an example process for generating a conformance score for an event data object in accordance with some embodiments discussed herein.

FIG. 5 provides an operational example of an ordered sequence of event data objects in accordance with some embodiments discussed herein.

FIG. 6 provides an operational example of an event encoding data object in accordance with some embodiments discussed herein.

FIG. 7 is a flowchart diagram of an example process for generating a state-level attention weight value and an attribute-level attention weight vector for an event encoding data object in accordance with some embodiments discussed herein.

FIG. 8 provides an operational example of a machine learning framework in accordance with some embodiments discussed herein.

FIG. 9 provides an operational example of a prediction output user interface that depicts the conformance score and a relative measure of the state-level attention weight value for each event encoding data object in accordance with some embodiments discussed herein.

FIG. 10 provides an operational example of a prediction output user interface that depicts the attribute-level attention weight value of an attribute-level attention weight vector for each event attribute feature with respect to a selected event encoding data object in accordance with some embodiments discussed herein.

FIG. 11 provides an operational example of a generative adversarial machine learning framework for each event encoding data object in accordance with some embodiments discussed herein.

### DETAILED DESCRIPTION

Various embodiments of the present invention now will be described more fully hereinafter with reference to the accompanying drawings, in which some, but not all, embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout. Moreover, while certain embodiments of the present invention are described with reference to predictive data analysis, one of ordinary skill in the art will recognize that the disclosed concepts can be used to perform other types of data analysis.

### I. OVERVIEW AND TECHNICAL IMPROVEMENTS

Various embodiments of the present invention introduce techniques for conformance determination that improve the training efficiency, the predictive accuracy, and the interpretability of conformance determination machine learning models by generating predictive inferences from distinctions between core event features and secondary event features. For example, various embodiments of the present invention introduce techniques for processing event state feature data associated with event data objects using a separate recurrent neural network machine learning model than the recurrent neural network machine learning model used to process event state feature data. This enables the resulting machine learning models that can perform conformance detection with a fewer number of training iterations and/or with a fewer number of training examples, a feature that in turn enhances the training efficiency of conformance determination machine learning models. Generating predictive inferences based at least in part on distinctions between core event features and secondary event features also enables a trained machine learning model to be more predictive than various conventional conformance detection models, thus improving the predictive accuracy of performing conformance detection.

Accordingly, by disclosing techniques for generating predictive inferences from distinctions between core event features and secondary event features, for example by using a separate recurrent neural network machine learning model than the recurrent neural network machine learning model used to process event state feature data, various embodiments of the present invention reduce the number of processing operations needed to train conformance checking operations and reduce the number of predictive inference iterations needed to generate conformance checking determinations. In this way, various embodiments of the present invention make important technical contributions to improving the operational efficiency and technical reliability of conformance checking machine learning models.

An example application of the techniques described in various embodiments of the present invention relates to conformance checking, which is an example of a process mining technique. Process mining is a family of techniques in the field of process management that support the analysis of business processes based at least in part on examining process event logs. During process mining, specialized data mining algorithms are applied to event log data in order to identify trends, patterns and details contained in event logs recorded by an information system. Process mining aims to improve process efficiency and understanding of processes. In accordance conformance checking, a prior model exists, or has been discovered (via process discovery) it can be used as a benchmark against the event logs to monitor and measure the conformance of the business process. There are many techniques for conformance checking but all strictly require that a prior model be in place to compare the actual event traces against the standard agreed-upon model. The standard models sometimes need to be semantically encoded to capture the standard rule-based behavior of the system for conformance checking. For example, conformance checking techniques which are replay based require the standard model to be encoded as a Petri-Net and then a system of token counting is applied in order to check the conformance of an event-trace or log.

The core limitation of conformance checking is the requirement to have a standard model. In general, if the system is simple or the ideal state can be well captured by a process expert, a standard model can be constructed with relative ease. However, most actual business processes are very complex. Typical discovery methods struggle to create a simple process flow of such a system let alone create the semantic description often needed for conformance checking. On one hand, if the discovery technique used is tuned to deliver an interpretable standard model, the model is usually quite rigid, and will not capture all of the possible allowable and typically normal behavior. This is known as a Lasagne process. On the other hand, if the discovery mechanism used is tuned to capture all of the allowable behavior in the system, than it can result in a hyper-connected Spaghetti network that will fail to generalize well.

Other issues in conformance checking include the inability to identify issues relating to complex interplay between the attributes of an event trace instance. Take an example of any instance of a process in a system, often there are 2 key components, the temporal event trace, (what states did the widget undergo) and the case-level attributes of the widget. The attributes can be changed or can remain fixed through the widget lifecycle. Traditional conformance checking mainly focuses on the order of the process and ensuring that the event trace or event state ordering was conforming, it fails to account for the combination of widget attributes and event trace which may cause a non-conformance.

To overcome the above-described issues associated with conventional conformance checking solutions, various embodiments of the present invention enable conformance checking without having to rely on a (sometimes impossible) process discovery step or without having a prior model and can we incorporate more complex rules into our abstract standard model such that the interplay between event trace and case level attributes can be incorporated into the conformance checking methodology. Various embodiments of the present invention describe using a generative adversarial neural network to perform conformance checking, with the use of attention layers on the discriminator component of the generative adversarial neural network to identify the root cause of the conformance issues.

Various embodiments of the present invention enable allows conformance checking for event traces to be accomplished without the use of a prior defined model. In this respect, various embodiments enable a conformance checking solution that is unique in comparison to all known existing checking techniques which do require a semantic prior model. It does so using generative adversarial neural networks which to date have not yet been used in this field nor has attention networks been used in the domain of process mining to introspect conformance issues. There are many benefits that this uniqueness brings to conformance checking that would not exist otherwise, such as: (i) the ability to threshold a conformance level in the continuous bounded space, as opposed to the binary compliance methods in traditional conformance checking; (ii) the ability to use any neural network as the discriminator, which allows introspection of both attribute level and event trace level conformance issues and the interrelationships between them (This is typically not possible in traditional conformance checking with primarily focusses on event trace only with little regard for the interplay with case-level attributes); and (iii) the ability to have a discriminator that can deliver a compliance score per each step, or prospectively (by training on partial event traces as well as full event traces, as opposed to traditional conformance checking which only gives a compliance score retrospectively on a full sequence).

### II. DEFINITIONS

The term “event data object” may refer to a data entity that is configured to describe one or more recorded features of an observed/recorded event. An example of an event data object is a data object that describes recorded features of a customer service delivery event, such a case identifier associated with the customer service delivery event, a timestamp associated with the customer service delivery event, a service medium associated with the customer service delivery event, an activity status associated with the customer service delivery event, a service line identifier associated with the customer service delivery event, an urgency level associated with the customer service delivery event, an urgency level identifier associated with the customer service delivery event, and/or the like. Another example of an event data object is a data object that describes recorded features of a medical service delivery event, such as a provider identifier associated with the medical service delivery event, patient demographic features associated with the medical service delivery event, a case identifier associated with the medical service delivery event, a timestamp associated with the medical service delivery event, a service medium associated with the medical service delivery event, an activity status associated with the medical service delivery event, a service line identifier associated with the medical service delivery event, an urgency level associated with the medical service delivery event, an urgency level identifier associated with the medical service delivery event, and/or the like. In some embodiments, an event data object is an attribute of n event features, where the n event features may include a set of event state features and a set of event attribute features.

The term “ordered sequence of event data objects” may refer to a data entity that is configured to describe a sequence of event data objects, where each event data object in the ordered sequence is associated with a position value that is distinct from the position values of other event data objects in the ordered sequence. For example, an ordered sequence of event data objects may order the event data objects in the ordered sequence based at least in part on a timestamp, such that an earliest event data object in the ordered sequence has a lowest position value, a second-earliest event data object in the ordered sequence has a second-lowest position value, and/or the like. Examples of ordered sequence event data objects include customer service delivery event data objects that are ordered based at least in part on service delivery timestamps, medical service delivery event data objects that are ordered based at least in part on service delivery timestamps, and/or the like.

The term “event state feature value” may refer to a data entity that is configured to describe an event feature value described by an event data object that is deemed to be a core feature value of the event data object, such that in some embodiments the collection of the event state features of an event data objects may be used to determine an event state of the event data object. Examples of event state features for a customer service delivery event include a case identifier associated with the customer service delivery event, a timestamp associated with the customer service delivery event, and an activity status associated with the customer service delivery event. Examples of event state features for a medical service delivery event include a case identifier associated with the medical service delivery event, a timestamp associated with the medical service delivery event, and an activity status associated with the medical service delivery event. In some embodiments, event state features of an event data object are described by configuration data associated with a predictive data analysis system that is configured to perform predictive inferences based at least in part on the event data objects. Moreover, while previous description assumes that an event data object can only be in a single state, if the states have been represented as a vector in the latent space then it can be possible to represent an event data object in multiple states to a machine learning framework (e.g., to a generative adversarial machine learning framework) using basic vector aggregation methods like element-wise mean or sum

The term “event attribute feature value” may refer to a data entity that is configured to describe an event feature value described by an event data object that is part of at least a subset of the feature values described by the event data object which are not deemed to be event state feature values of the event data objects. In some embodiments, an event attribute feature of an event data object may describe a feature value described by an event data object that is not deemed to be a core feature of the event data object, such that in some embodiments the collection of the event attribute features of an event data objects may be used to perform secondary non-state-based inferences based at least in part on non-core features of the event data objects. Examples of event attribute features for a customer service delivery event data object include a service medium associated with the customer service delivery event, a service line identifier associated with the customer service delivery event, an urgency level associated with the customer service delivery event, an urgency level identifier associated with the customer service delivery event, and/or the like. Examples of event attribute features for a medical service delivery event data object include a provider identifier associated with the medical service delivery event, patient demographic features associated with the medical service delivery event, a service medium associated with the medical service delivery event, an activity status associated with the medical service delivery event, a service line identifier associated with the medical service delivery event, an urgency level associated with the medical service delivery event, an urgency level identifier associated with the medical service delivery event, and/or the like. In some embodiments, event attribute features of an event data object are described by configuration data associated with a predictive data analysis system that is configured to perform predictive inferences based at least in part on the event data objects.

The term “event encoding data object” may refer to a data entity that is configured to describe an encoded representation of an event data object. In some embodiments, to generate an event encoding data object, the feature values of the event data object are processed using an encoding algorithm to generate a defined-size representation of the event data object. In some embodiments, an event encoding data object includes an event state encoding and an event attribute encoding, where the event state encoding may describe a defined-size representation of event state attributes of a corresponding event data object, and the event attribute encoding may describe a defined-size representation of event attribute attributes of a corresponding event data object. An event encoding data object may be a vector.

The term “ordered sequence of event encoding data objects” may refer to a data entity that is configured to describe a sequence of event encoding data objects, where each event encoding data object in the ordered sequence is associated with a position value that is distinct from the position values of other event encoding data objects in the ordered sequence. For example, an ordered sequence of event data objects may order the event encoding data objects in the ordered sequence based at least in part on timestamps of corresponding event data objects associated with the event encoding data objects in the ordered sequence, such that an earliest event encoding data object in the ordered sequence has a lowest position value, a second-earliest event encoding data object in the ordered sequence has a second-lowest position value, and/or the like.

The term “event state encoding” may refer to a data entity that is configured to describe a defined-size representation of event state attribute features of a corresponding event data object. For example, in some embodiments, generating an event state encoding for an event data object includes generating a one-hot-coded representation of each event state feature of the event data object, aggregating the one-hot-coded representations of the event state features to generate an initial event state encoding, and performing dimensionality reduction on the initial event state encoding to generate the event state encoding. As another example, in some embodiments, generating an event state encoding for an event data object includes generating a one-hot-coded representation of each event state feature of the event data object, aggregating the one-hot-coded representations of the event state features to generate an initial event state encoding, and generating the event state encoding based at least in part on the initial event state encoding. As yet another example, in some embodiments, generating an event state encoding for an event data object includes generating a one-hot-coded representation of each event state feature of the event data object, and performing dimensionality reduction on the one-hot-coded representations of the event state features to generate the event state encoding. Although various embodiments of the present invention describe generating event state encodings based on one-hot-coded representations, a person of ordinary skill in the relevant technology will recognize that any appropriate numeric representation of categorical data (e.g., a numeric representation using latent embedded spaces) may be used.

The term “event attribute encoding” may refer to a data entity that is configured to describe a defined-size representation of event attribute features of a corresponding event data object, where each event attribute encoding value of the event attribute encoding is associated with an event attribute feature of the event attribute features described by the event encoding data object. For example, in some embodiments, generating an event attribute encoding for an event data object includes generating a one-hot-coded representation of each event attribute feature of the event data object and aggregating the one-hot-coded representations of the event attribute features to generate the event attribute encoding.

The term “machine learning framework” may refer to a data entity that is configured to describe a trained machine learning framework that includes two or more recurrent neural network machine learning models. In some embodiments, the machine learning framework includes two or more machine learning models have a similar recurrent neural network type. For example, the recurrent neural network may include two or more conventional recurrent neural network machine learning models, two or more long short term memory neural networks, two or more gated recurrent units, and/or the like. In some embodiments, the machine learning framework includes two or more machine learning models that have different recurrent neural network types. For example, a machine learning framework may include one or more conventional recurrent neural network machine learning models, one or more long short term memory neural networks, one or more gated recurrent units, and/or the like. The two or more recurrent neural network machine learning models of the machine learning framework may include a state processing recurrent neural network machine learning model and an attribute processing machine learning model. In some embodiments, the machine learning framework includes one or more of: (i) at least one recurrent neural network (RNN) model (e.g., a bi-directional RNN model and/or a multi-layered RNN model), (ii) at least one convolutional neural network-recurrent neural network (CNN-RNN) model, (iii) at least one gated recurrent unit (GRU) model, (iv) at least one long short term memory (LSTM) model, and/or the like.

The term “state processing recurrent neural network machine learning model” may refer to a data entity that is configured to describe parameters, hyper-parameters, and/or defined operations of a recurrent neural network machine learning model that is configured to process an event encoding data object to generate a state-level attention weight value for the event data object. In some embodiments, the state processing event recurrent neural network machine learning model is configured to process an event encoding data object to generate a hidden state vector for the encoded event data object, then process the hidden state vector in accordance with the parameters (e.g., weights and/or biases) of the state processing recurrent neural network machine learning model to generate a state processing model output for the encoded event data object, and then generates the state-level attention weight value for the encoded event data object based at least in part on the state processing model output for the encoded event data object (e.g., based at least in part on an output of normalizing the state processing model output across the state processing model outputs of a preceding subset of the ordered sequence of event encoding data objects that occur prior to the current event encoding data object). In some embodiments, the state processing recurrent neural network machine learning model is a long short term memory machine learning model. The state processing recurrent neural network machine learning model may be an attention-based machine learning model, such as a machine learning model that uses self-attention, masked attention, and/or the like.

The term “state-level attention weight value” may refer to a data entity that is configured to describe the output of processing an event encoding data object using a state processing machine learning model. In some embodiments, a state-level attention weight value may describe an atomic value that describes an inferred predictive significance of the event state encoding of the event encoding data object to the conformance score for the event encoding data object.

The term “attribute processing machine learning model” may refer to a data entity that is configured to describe parameters, hyper-parameters, and/or defined operations recurrent neural network machine learning model that is configured to process an event encoding data object to generate an attribute-level attention weight vector for the event data object. In some embodiments, the attribute processing event recurrent neural network machine learning model is configured to process an event encoding data object to generate a hidden state vector for the encoded event data object, then process the hidden state vector in accordance with the parameters (e.g., weights and/or biases) of the attribute processing recurrent neural network machine learning model and using an activation function (e.g., a hyperbolic tangent activation function) to generate the attribute-level attention weight vector for the event data object. In some embodiments, the attribute processing recurrent neural network machine learning model is a long short term memory machine learning model. The attribute processing recurrent neural network machine learning model may be an attention-based machine learning model, such as a machine learning model that uses self-attention, masked attention, and/or the like.

The term “attribute-level attention weight value” may refer to a data entity that is configured to describe the output of processing an event encoding data object using an attribute processing machine learning model. In some embodiments, an attribute-level attention weight value may describe a vector, where each value of the vector describes an inferred predictive significance of a corresponding event attribute feature value of the event encoding data object to the conformance score for the event encoding data object.

### III. COMPUTER PROGRAM PRODUCTS, METHODS, AND COMPUTING ENTITIES

Embodiments of the present invention may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations. Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### IV. EXEMPLARY SYSTEM ARCHITECTURE

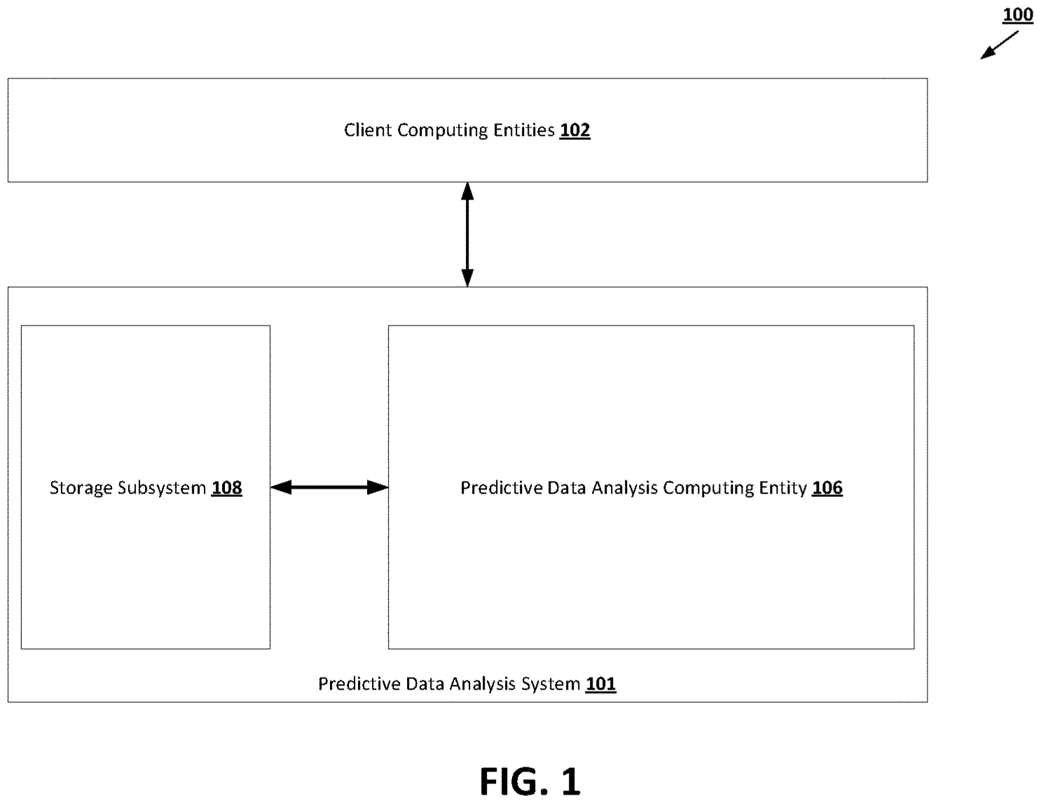

FIG. 1 is a schematic diagram of an example architecture 100 for performing predictive data analysis. The architecture 100 includes a predictive data analysis system 101 configured to receive predictive data analysis requests from client computing entities 102, process the predictive data analysis requests to generate predictions, provide the generated predictions to the client computing entities 102, and automatically perform prediction-based actions based at least in part on the generated predictions. An example of a prediction-based action that can be performed using the predictive data analysis system 101 is a request for generating a disease risk score based at least in part on at least one of patient genomic data, patient behavioral data, patient clinical data, and/or the like.

In some embodiments, predictive data analysis system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

The predictive data analysis system 101 may include a predictive data analysis computing entity 106 and a storage subsystem 108. The predictive data analysis computing entity 106 may be configured to receive predictive data analysis requests from one or more client computing entities 102, process the predictive data analysis requests to generate predictions corresponding to the predictive data analysis requests, provide the generated predictions to the client computing entities 102, and automatically perform prediction-based actions based at least in part on the generated predictions.

The storage subsystem 108 may be configured to store input data used by the predictive data analysis computing entity 106 to perform predictive data analysis as well as model definition data used by the predictive data analysis computing entity 106 to perform various predictive data analysis tasks. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

### Exemplary Predictive Data Analysis Computing Entity

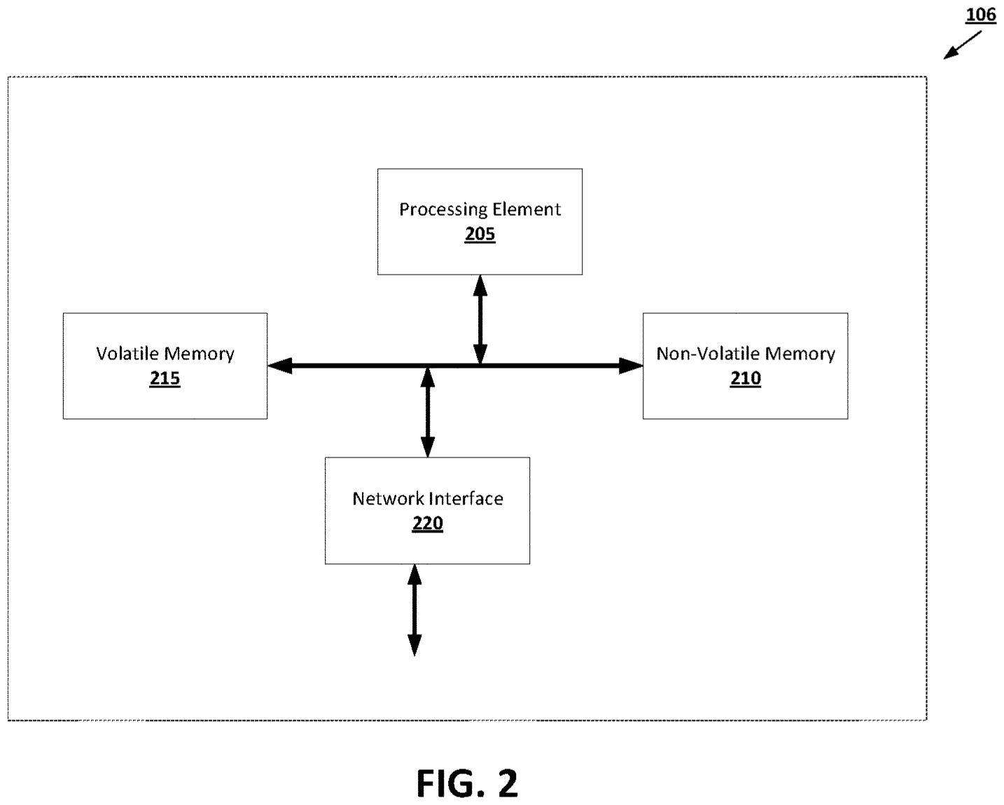

FIG. 2 provides a schematic of a predictive data analysis computing entity 106 according to one embodiment of the present invention. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the predictive data analysis computing entity 106 may also include one or more communications interfaces 220 for communicating with various computing entities, such as by communicating data, content, information, and/or similar terms used herein interchangeably that can be transmitted, received, operated on, processed, displayed, stored, and/or the like.

As shown in FIG. 2, in one embodiment, the predictive data analysis computing entity 106 may include, or be in communication with, one or more processing elements 205 (also referred to as processors, processing circuitry, and/or similar terms used herein interchangeably) that communicate with other elements within the predictive data analysis computing entity 106 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the predictive data analysis computing entity 106 may further include, or be in communication with, non-volatile media (also referred to as non-volatile storage, memory, memory storage, memory circuitry and/or similar terms used herein interchangeably). In one embodiment, the non-volatile storage or memory may include one or more non-volatile storage or memory media 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the predictive data analysis computing entity 106 may further include, or be in communication with, volatile media (also referred to as volatile storage, memory, memory storage, memory circuitry and/or similar terms used herein interchangeably). In one embodiment, the volatile storage or memory may also include one or more volatile storage or memory media 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the predictive data analysis computing entity 106 with the assistance of the processing element 205 and operating system.

As indicated, in one embodiment, the predictive data analysis computing entity 106 may also include one or more communications interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the predictive data analysis computing entity 106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the predictive data analysis computing entity 106 may include, or be in communication with, one or more input elements, such as a keyboard input, a mouse input, a touch screen/display input, motion input, movement input, audio input, pointing device input, joystick input, keypad input, and/or the like. The predictive data analysis computing entity 106 may also include, or be in communication with, one or more output elements (not shown), such as audio output, video output, screen/display output, motion output, movement output, and/or the like.

### Exemplary Client Computing Entity

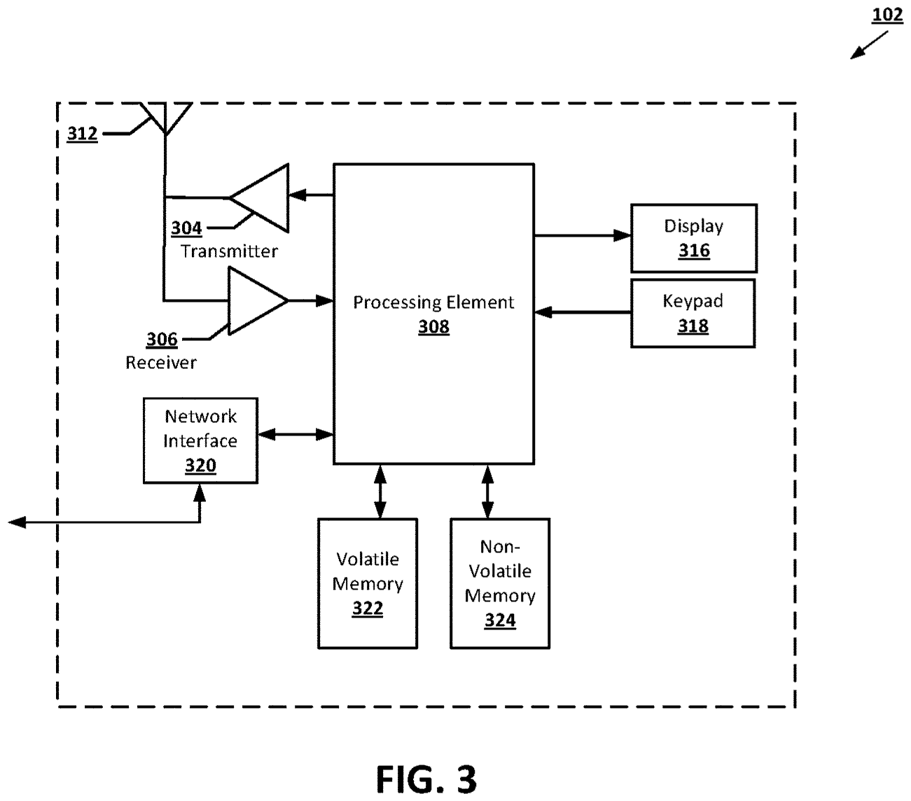

FIG. 3 provides an illustrative schematic representative of an client computing entity 102 that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 can be operated by various parties. As shown in FIG. 3, the client computing entity 102 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the predictive data analysis computing entity 106. In a particular embodiment, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the predictive data analysis computing entity 106 via a network interface 320.

Via these communication standards and protocols, the client computing entity 102 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 can also download changes, add-ons, and updates, for instance, to its firmware, software (e.g., including executable instructions, applications, program modules), and operating system.

According to one embodiment, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the client computing entity's 102 position in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The client computing entity 102 may also comprise a user interface (that can include a display 316 coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the predictive data analysis computing entity 106, as described herein. The user input interface can comprise any of a number of devices or interfaces allowing the client computing entity 102 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The client computing entity 102 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the client computing entity 102. As indicated, this may include a user application that is resident on the entity or accessible through a browser or other user interface for communicating with the predictive data analysis computing entity 106 and/or various other computing entities.

In another embodiment, the client computing entity 102 may include one or more components or functionality that are the same or similar to those of the predictive data analysis computing entity 106, as described in greater detail above. As will be recognized, these architectures and descriptions are provided for exemplary purposes only and are not limiting to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### V. EXEMPLARY SYSTEM OPERATIONS

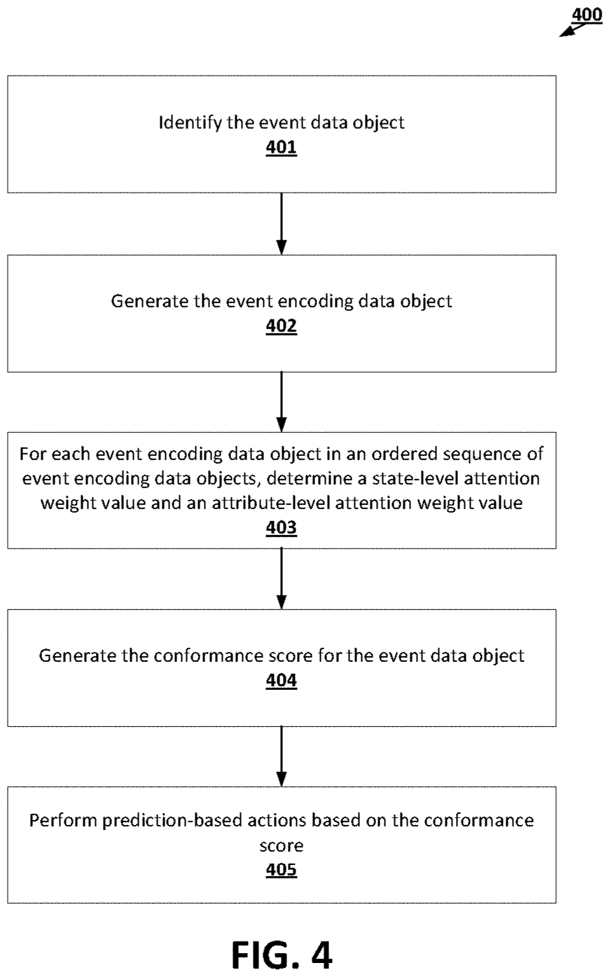

FIG. 4 is a flowchart diagram of an example process 400 for generating a conformance score for an event data object. Via the various steps/operations of the process 400, the predictive data analysis computing entity 106 can generate predictive inferences based at least in part on distinctions between core event features and secondary event features of event data objects in order to enable utilizing event processing machine learning models that have a higher training efficiency, have a higher predictive accuracy, and are more interpretable.

The process 400 begins at step/operation 401 when the predictive data analysis computing entity 106 identifies the event data object. The event data objects may in some embodiments be part of an event data object provided to the predictive data analysis computing entity by an external computing entity, such as by a client computing entity.

In some embodiments, an event data object describes one or more recorded features of an observed/recorded event. An example of an event data object is a data object that describes recorded features of a customer service delivery event, such a case identifier associated with the customer service delivery event, a timestamp associated with the customer service delivery event, a service medium associated with the customer service delivery event, an activity status associated with the customer service delivery event, a service line identifier associated with the customer service delivery event, an urgency level associated with the customer service delivery event, an urgency level identifier associated with the customer service delivery event, and/or the like. Another example of an event data object is a data object that describes recorded features of a medical service delivery event, such as a provider identifier associated with the medical service delivery event, patient demographic features associated with the medical service delivery event, a case identifier associated with the medical service delivery event, a timestamp associated with the medical service delivery event, a service medium associated with the medical service delivery event, an activity status associated with the medical service delivery event, a service line identifier associated with the medical service delivery event, an urgency level associated with the medical service delivery event, an urgency level identifier associated with the medical service delivery event, and/or the like. In some embodiments, an event data object is an attribute of n event features, where the n event features may include a set of event state features and a set of event attribute features.

In some embodiments, the event data object is part of an ordered sequence of event data objects. An ordered sequence of event data objects may describe a sequence of event data objects, where each event data object in the ordered sequence is associated with a position value that is distinct from the position values of other event data objects in the ordered sequence. For example, an ordered sequence of event data objects may order the event data objects in the ordered sequence based at least in part on a timestamp, such that an earliest event data object in the ordered sequence has a lowest position value, a second-earliest event data object in the ordered sequence has a second-lowest position value, and/or the like. Examples of ordered sequence event data objects include customer service delivery event data objects that are ordered based at least in part on service delivery timestamps, medical service delivery event data objects that are ordered based at least in part on service delivery timestamps, and/or the like.

In some embodiments, an event data object may include one or more event state feature values. An event state feature value of an event data object may describe an event feature value described by an event data object that is deemed to be a core feature value of the event data object, such that in some embodiments the collection of the event state features of an event data objects may be used to determine an event state of the event data object. Examples of event state features for a customer service delivery event include a case identifier associated with the customer service delivery event, a timestamp associated with the customer service delivery event, and an activity status associated with the customer service delivery event. Examples of event state features for a medical service delivery event include a case identifier associated with the medical service delivery event, a timestamp associated with the medical service delivery event, and an activity status associated with the medical service delivery event. In some embodiments, event state features of an event data object are described by configuration data associated with a predictive data analysis system that is configured to perform predictive inferences based at least in part on the event data objects.

In some embodiments, an event data object may include one or more event attribute feature values. An event attribute feature value of an event data object may describe an event feature value described by an event data object that is part of at least a subset of the feature values described by the event data object which are not deemed to be event state feature values of the event data objects. In some embodiments, an event attribute feature of an event data object may describe a feature value described by an event data object that is not deemed to be a core feature of the event data object, such that in some embodiments the collection of the event attribute features of an event data objects may be used to perform secondary non-state-based inferences based at least in part on non-core features of the event data objects. Examples of event attribute features for a customer service delivery event data object include a service medium associated with the customer service delivery event, a service line identifier associated with the customer service delivery event, an urgency level associated with the customer service delivery event, an urgency level identifier associated with the customer service delivery event, and/or the like. Examples of event attribute features for a medical service delivery event data object include a provider identifier associated with the medical service delivery event, patient demographic features associated with the medical service delivery event, a service medium associated with the medical service delivery event, an activity status associated with the medical service delivery event, a service line identifier associated with the medical service delivery event, an urgency level associated with the medical service delivery event, an urgency level identifier associated with the medical service delivery event, and/or the like. In some embodiments, event attribute features of an event data object are described by configuration data associated with a predictive data analysis system that is configured to perform predictive inferences based at least in part on the event data objects.

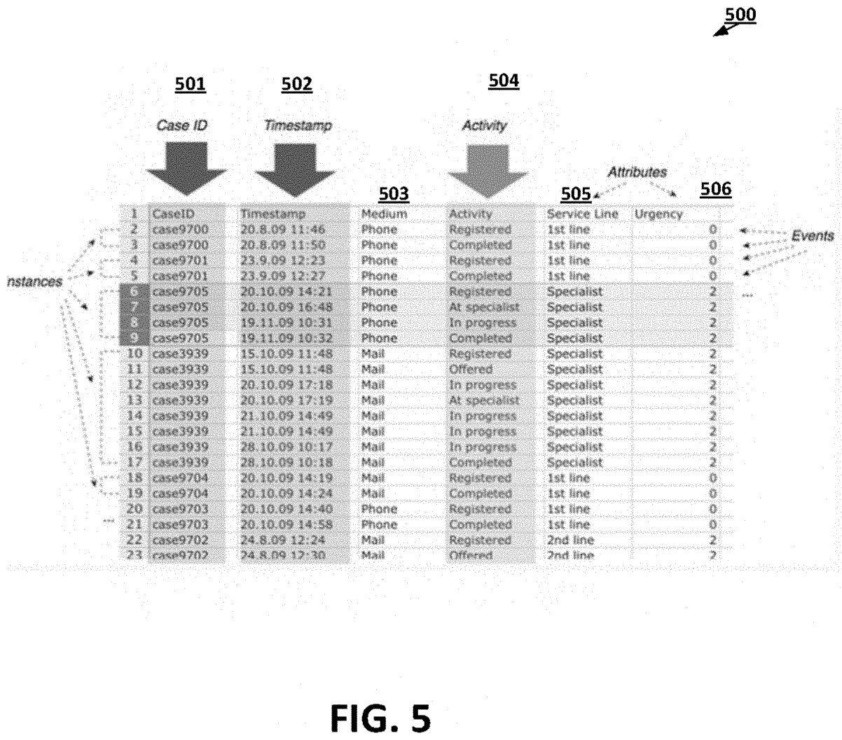

An operational example of an ordered sequence 500 of event data objects that are ordered based at least in part on timestamp event feature values 502 is depicted in FIG. 5. As depicted in FIG. 5, each event data object in the ordered sequence 500 is associated with the following event state feature values: a case identifier event feature value 501, a time stamp event feature value 502, and an activity status event feature value 502. As further depicted in FIG. 5, each event data object in the ordered sequence 500 is associated with the following event attribute feature values: a service medium event feature value 503, a service line event feature value 505, and an event urgency level identifier event feature value 506.

Returning to FIG. 4, at step/operation 402, the predictive data analysis computing entity 106 generates an event encoding data object based at least in part on the event data object. An event encoding data object may describe an encoded representation of an event data object. In some embodiments, to generate an event encoding data object, the feature values of the event data object are processed using an encoding algorithm to generate a defined-size representation of the event data object. In some embodiments, an event encoding data object includes an event state encoding and an event attribute encoding, where the event state encoding may describe a defined-size representation of event state attributes of a corresponding event data object, and the event attribute encoding may describe a defined-size representation of event attribute attributes of a corresponding event data object.

In some embodiments, the event encoding data object may be part of an ordered sequence of event encoding data objects, where an ordered sequence of event encoding data objects may describe a sequence of event encoding data objects, and where each event encoding data object in the ordered sequence is associated with a position value that is distinct from the position values of other event encoding data objects in the ordered sequence. For example, an ordered sequence of event data objects may order the event encoding data objects in the ordered sequence based at least in part on timestamps of corresponding event data objects associated with the event encoding data objects in the ordered sequence, such that an earliest event encoding data object in the ordered sequence has a lowest position value, a second-earliest event encoding data object in the ordered sequence has a second-lowest position value, and/or the like.

In some embodiments, an event encoding data object includes an event state encoding. An event state encoding may describe a defined-size representation of event state attribute features of a corresponding event data object. For example, in some embodiments, generating an event state encoding for an event data object includes generating a one-hot-coded representation of each event state feature of the event data object, aggregating the one-hot-coded representations of the event state features to generate an initial event state encoding, and performing dimensionality reduction on the initial event state encoding to generate the event state encoding. As another example, in some embodiments, generating an event state encoding for an event data object includes generating a one-hot-coded representation of each event state feature of the event data object, aggregating the one-hot-coded representations of the event state features to generate an initial event state encoding, and generating the event state encoding based at least in part on the initial event state encoding. As yet another example, in some embodiments, generating an event state encoding for an event data object includes generating a one-hot-coded representation of each event state feature of the event data object, and performing dimensionality reduction on the one-hot-coded representations of the event state features to generate the event state encoding.

In some embodiments, an event encoding data object includes an event attribute encoding. An event attribute encoding may describe a defined-size representation of event attribute features of a corresponding event data object, where each event attribute encoding value of the event attribute encoding is associated with an event attribute feature of the event attribute features described by the event encoding data object. For example, in some embodiments, generating an event attribute encoding for an event data object includes generating a one-hot-coded representation of each event attribute feature of the event data object and aggregating the one-hot-coded representations of the event attribute features to generate the event attribute encoding.

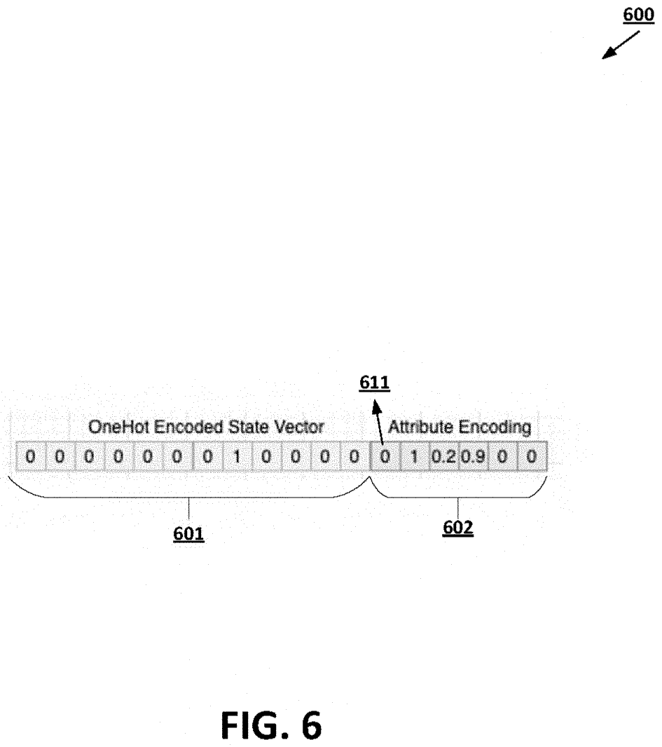

An operational example of an event encoding data object 600 is depicted in FIG. 6. As depicted in FIG. 6, the event encoding data object 600 includes the event state encoding 601 and the event attribute encoding 602. As further depicted in FIG. 6, the event attribute encoding 602 includes, for each event attribute feature value of the corresponding event data object associated with the event encoding data object 600, a value. For example, the value 611 is associated with a first event attribute feature value of the corresponding event data object associated with the event encoding data object 600.

Returning to FIG. 4, at step/operation 403, the predictive data analysis computing entity 106 processes each event encoding data object using a machine learning framework to generate a state-level attention weight value for the event encoding data object and an attribute-level attention weight vector for the event encoding data object. In some embodiments, during each ith timestamp of the machine learning framework, the predictive data analysis computing entity 106 causes the machine learning framework to generate the ith state-level attention weight value for the ith event encoding data object and the ith attribute-level attention weight vector for the ith event encoding data object.

In some embodiments, a machine learning framework may be a trained machine learning framework that includes two or more recurrent neural network machine learning models. In some embodiments, the machine learning framework includes two or more machine learning models have a similar recurrent neural network type. For example, the recurrent neural network may include two or more conventional recurrent neural network machine learning models, two or more long short term memory neural networks, two or more gated recurrent units, and/or the like. In some embodiments, the machine learning framework includes two or more machine learning models that have different recurrent neural network types. For example, a machine learning framework may include one or more conventional recurrent neural network machine learning models, one or more long short term memory neural networks, one or more gated recurrent units, and/or the like.

In some embodiments, the two or more recurrent neural network machine learning models of the machine learning framework may include a state processing recurrent neural network machine learning model and an attribute processing machine learning model. In some embodiments, a state processing recurrent neural network machine learning model may be a recurrent neural network machine learning model that is configured to process an event encoding data object to generate a state-level attention weight value for the event data object. In some embodiments, the state processing event recurrent neural network machine learning model is configured to process an event encoding data object to generate a hidden state vector for the encoded event data object, then process the hidden state vector in accordance with the parameters (e.g., weights and/or biases) of the state processing recurrent neural network machine learning model to generate a state processing model output for the encoded event data object, and then generates the state-level attention weight value for the encoded event data object based at least in part on the state processing model output for the encoded event data object (e.g., based at least in part on an output of normalizing the state processing model output across the state processing model outputs of a preceding subset of the ordered sequence of event encoding data objects that occur prior to the current event encoding data object). In some embodiments, an attribute processing machine learning model may be a recurrent neural network machine learning model that is configured to process an event encoding data object to generate an attribute-level attention weight vector for the event data object. In some embodiments, the attribute processing event recurrent neural network machine learning model is configured to process an event encoding data object to generate a hidden state vector for the encoded event data object, then process the hidden state vector in accordance with the parameters (e.g., weights and/or biases) of the attribute processing recurrent neural network machine learning model and using an activation function (e.g., a hyperbolic tangent activation function) to generate the attribute-level attention weight vector for the event data object.

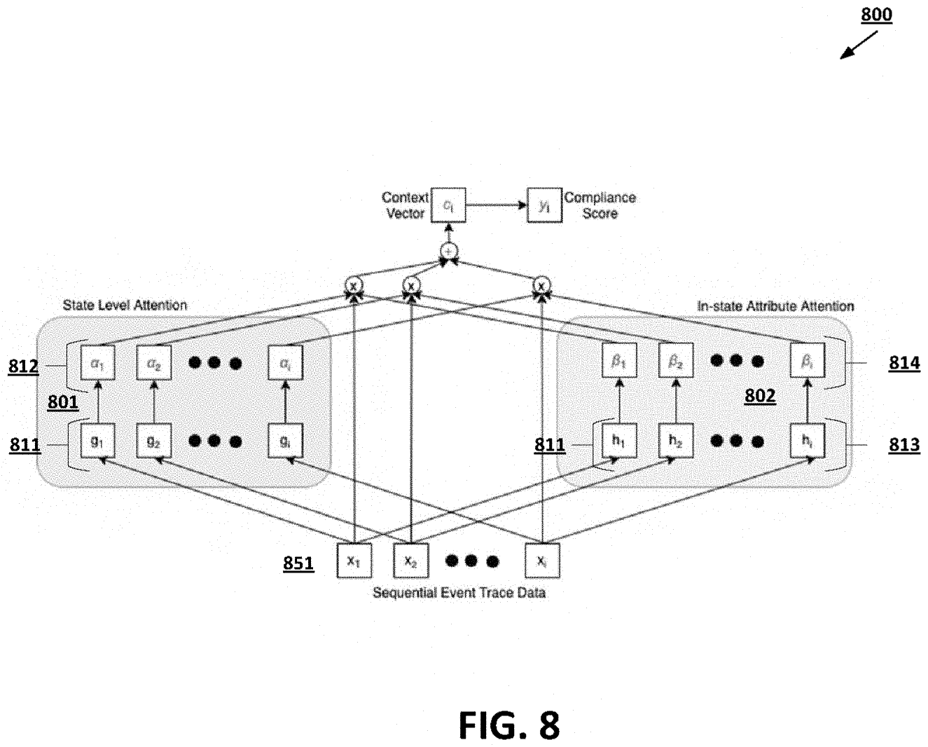

An operational example of a machine learning framework 800 is depicted in FIG. 8. As depicted in FIG. 8, the machine learning framework 800 includes a state processing machine learning model 801 that is configured to generate hidden states 811 and then state-level attention weight values 812 based at least in part on event encoded data objects 851. As further depicted in FIG. 8, the machine learning framework 800 includes an attribute processing machine learning model 802 that is configured to generate hidden states 813 and then attribute-level attention weight vectors 814 based at least in part on the event encoded data objects 851.

In some embodiments, the inputs to the state processing machine learning framework include, at each timestamp, an event encoding data object which is a vector. In some embodiments, the output of the state processing machine learning model is, for each timestamp, a state-level attention weight value which is an atomic value. In some embodiments, the inputs to the attribute processing machine learning framework include, at each timestamp, an event encoding data object which is a vector. In some embodiments, the output of the attribute processing machine learning model is, for each timestamp, an attribute-level attention weight vector which is a vector. In some embodiments, the inputs to the machine learning framework include, at each timestamp, an event encoding data object which is a vector. In some embodiments, the outputs of the machine learning framework include, for each timestamp, a conformance score which may be a vector and/or an atomic value.

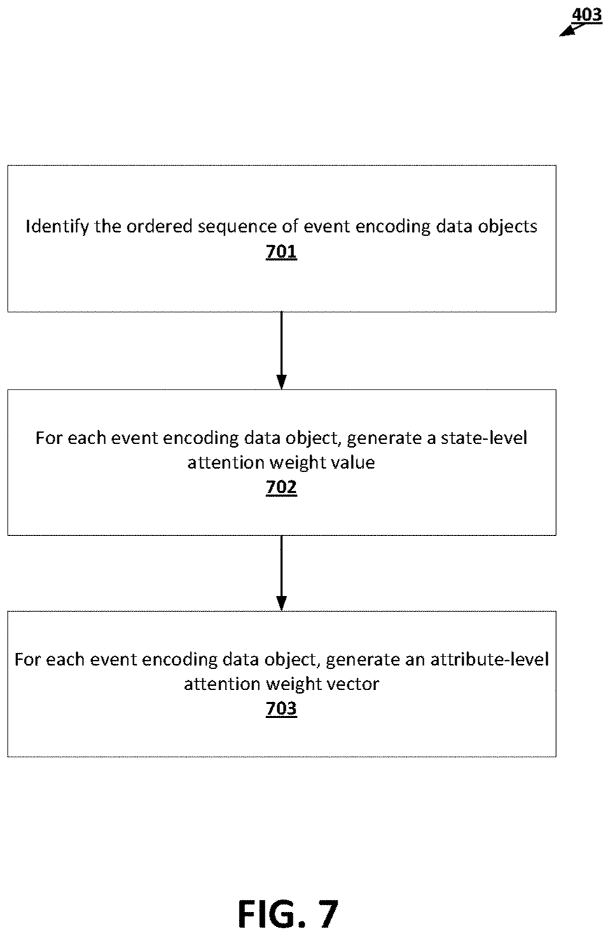

In some embodiments, step/operation 403 may be performed in accordance with the process that is depicted in FIG. 7. The process that is depicted in FIG. 5 begins at step/operation 701 when the predictive data analysis computing entity 106 identifies an ordered sequence of event encoding data objects. As described above, an ordered sequence of event encoding data objects may describe a sequence of event encoding data objects, where each event encoding data object in the ordered sequence is associated with a position value that is distinct from the position values of other event encoding data objects in the ordered sequence. For example, an ordered sequence of event data objects may order the event encoding data objects in the ordered sequence based at least in part on timestamps of corresponding event data objects associated with the event encoding data objects in the ordered sequence, such that an earliest event encoding data object in the ordered sequence has a lowest position value, a second-earliest event encoding data object in the ordered sequence has a second-lowest position value, and/or the like.

At step/operation 702, the predictive data analysis computing entity 106 processes each event encoding data object using the state processing machine learning model to generate a state-level attention weight value for the event encoding data object. In some embodiments, given the event encoding data objects x₁, . . . , xᵢ, the state processing machine learning model may perform operations corresponding to Equations 1-3 in order to generate corresponding state-level attention weight values, i.e., α₁, . . . , αᵢ values:

g₁, . . . ,gᵢ=RNN_{α}(x₁, . . . ,xᵢ) Equation 1

eⱼ=w_{α}^{T}gⱼ+b_{α}, ∀j=1, . . . ,i Equation 2

α₁, . . . ,αᵢ=Softmax(e₁, . . . eᵢ) Equation 3

In Equations 1-3, RNN_{α} is the state processing machine learning model, g₁, . . . , gᵢ are hidden states generated by the state processing machine learning models for the event encoding data objects x₁, . . . , xᵢ, w_{α}^{T} is a transposed weight matrix for the state processing machine learning model, b_{α} is the bias vector for state processing machine learning model, eⱼ is the initial model output of state processing machine learning model after i timestamps corresponding to i encoded event data objects, and Softmax is a softmax normalization operation.

In some embodiments, the state-level attention weight value may describe the output of processing an event encoding data object using a state processing machine learning model. In some embodiments, a state-level attention weight value may describe an atomic value that describes an inferred predictive significance of the event state encoding of the event encoding data object to the conformance score for the event encoding data object.

At operation 703, the predictive data analysis computing entity 106 processes each event encoding data object using the attribute processing machine learning model to generate an attribute-level attention weight vector for the event encoding data object. In some embodiments, given the event encoding data objects x₁, . . . , xᵢ, the attribute processing machine learning model may perform operations corresponding to Equations 4-5 in order to generate the corresponding attribute-level attention weight vector for the jth event encoded data object, i.e., βⱼ values:

h₁, . . . ,hᵢ=RNN_{β}(x₁, . . . ,xᵢ) Equation 4

βⱼ=tanh(W_{β}hⱼ+b_{β}), ∀j=1, . . . ,i Equation 5

In Equations 4-5, RNN_{β} is the attribute processing machine learning model, h₁, . . . , hᵢ, are hidden states generated by the state processing machine learning models for the event encoding data objects x₁, . . . , xᵢ, W_{β} is the weight matrix of attribute processing machine learning model, b_{β} is the bias vector of attribute processing machine learning model, and tanh is a hyperbolic tangent function which is an example of an activation function.

Returning to FIG. 4, at step/operation 404, the predictive data analysis computing entity 106 generates the conformance score for the event encoded data object. In some embodiments, the predictive data analysis computing entity 106 generates the conformance score based at least in part on: (i) each state-level attention weight value for a current subset of the ordered sequence that comprises the current event encoding data object and each event encoding data object that has a lower position value relative to the current event encoding data object in accordance with the ordered sequence, and (ii) each attribute-level attention weight vector for the current subset.

In some embodiments, to generate the conformance score for the ith event encoded data object, the predictive data analysis computing entity 106 performs operations described by the Equations 6-7 provided below:

$${c}_{i} = {\sum }_{j = 1}^{i} {α}_{j} {β}_{j} ⊗ {x}_{j} \qquad Equation 7$$

ŷᵢ=Softmax(Wcᵢ+b) Equation 8

In Equations 7-8, α₁ is the state-level attention weight value for the jth event encoded data object, βⱼ is the attribute-level attention weight vector for the jth event encoded data object, xⱼ is the jth event encoded data object, ci is the context vector for the ith event encoding data object (which in turn corresponds to the ith event data object), W is a set of trained weights, b is a set of trained bias values, ŷᵢ is the conformance score for the ith event encoding data object (which in turn corresponds to the ith event data object), and Softmax is a softmax normalization function.

At step/operation 405, the predictive data analysis computing entity 106 performs one or more prediction-based actions operations. In some embodiments, performing the one or more prediction-based actions comprises generating user interface data for a prediction output user interface that depicts the conformance score for each event encoding data object in the ordered sequence. In some embodiments, performing the one or more prediction-based actions comprise generating user interface data for a prediction output user interface that depicts the state-level attention weight value for each event encoding data object in the ordered sequence. In some embodiments, generated user interface data is used to generate a prediction output user interface that is generated to an end user of the predictive data analysis computing entity 106 and/or to an end user of a client computing entity 102.

In some embodiments, performing the one or more prediction-based actions comprises generating user interface data for a prediction output user interface that depicts each attribute-level in-state contribution score for a particular event encoding data object. In some embodiments, the attribute-level in-state contribution score of a particular event attribute feature of a particular event encoding data object describes an inferred predictive significance of the event feature value corresponding to the particular event attribute feature to a conformance score of the particular event encoding data object. In some embodiments, the attribute-level in-state contribution score for a kth event attribute feature of a jth event encoding data object is determined based at least in part on the state-level attention weight value for the jth event encoding data object, the attribute-level attention weight vector for the jth event encoding data object, one or more trained parameters (e.g., of the machine learning framework), and the and a target value of the jth event encoding data object that corresponds to the kth event attribute feature. For example, in some embodiments, the attribute-level in-state contribution score for a kth event attribute feature of a jth event encoding data object is determined by performing the operations of Equation 9 provided below:

αⱼβⱼWx_{j,k} Equation 9

In Equation 9, α₁ is the state-level attention weight value of the jth event encoding data object, βⱼ is the attribute-level attention weight vector of the jth event encoding data object, W is a set of trained weights, and x_{j,k} is the event feature value corresponding to the kth event attribute feature of the jth event encoding data object.

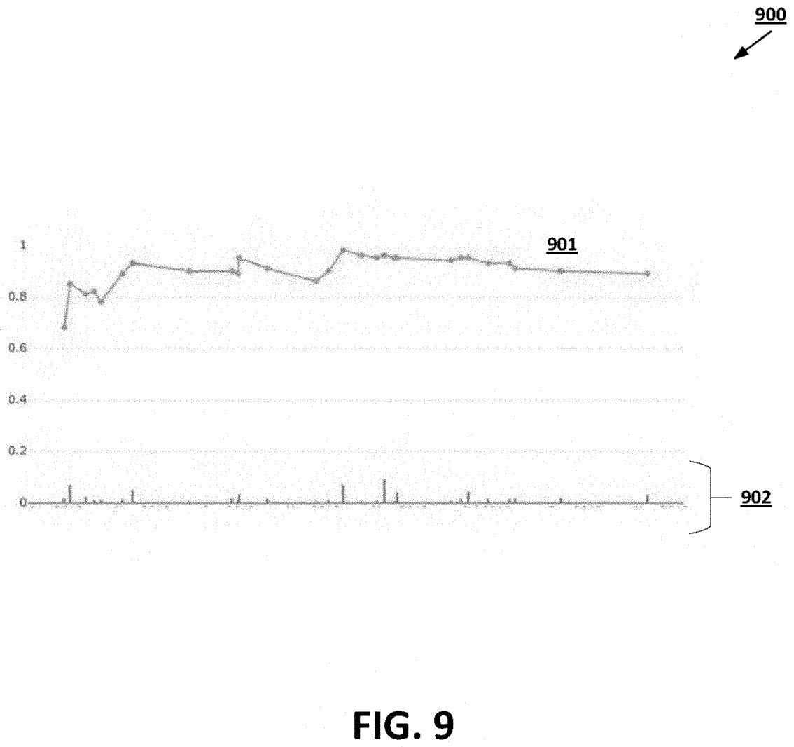

An operational example of a prediction output user interface 900 is depicted in FIG. 9. As depicted in FIG. 9, the prediction output user interface 900 includes a graph user interface element 901 that comprises various graph points, where each graph point describes (via the vertical value of the graph point) a conformance value for an encoded event data object corresponding to the horizontal value of the graph point. The horizontal coordinate of the graph user interface element 901 may include an ordering of event encoding data objects that is determined based at least in part on the ordering defined by the ordered sequence of event data objects. As further depicted in FIG. 9, each graph bar of the graph bars 902 depicted in the prediction output user interface 900 describes a relative value of the state-level attention weight value for an encoded event data object corresponding to the horizontal value of the graph bar.

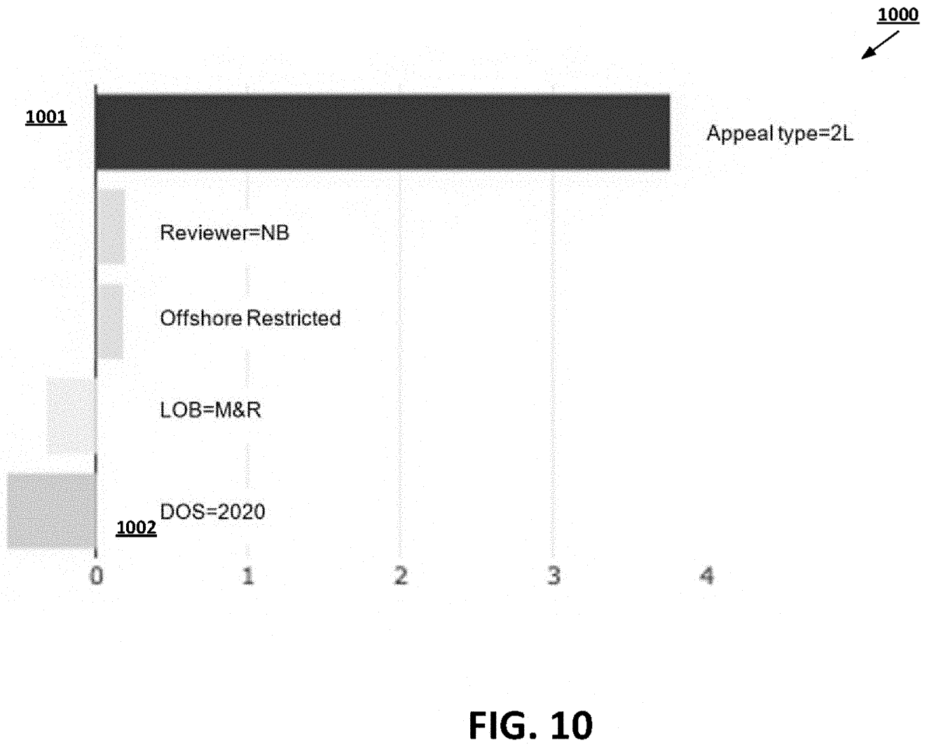

Another operational example of a prediction output user interface 1000 is depicted in FIG. 10. As depicted in FIG. 10, the prediction output user interface 1000 includes various graphs bars, where each graph bars depicts the value of the attribute-level attention weight vector for a selected event encoding data object, where the value corresponds to an event attribute feature of the selected event encoding data object. For example, as depicted in FIG. 10, the graph bar 1001 depicts that the event attribute feature value of a corresponding event data object that described that the event data object had an 2L Appeal Type had the largest attribute-level attention weight vector value for the conformance score of the selected event encoding data object, while the graph bar 1002 depicts that the event attribute feature value of a corresponding event data object that described that the event data object had a 2020 DOS had a negative attribute-level attention weight vector value for the conformance score of the selected event encoding data object.

In some embodiments, the machine learning framework is generated using all of an ordered sequence of event encoding data objects. In some embodiments, the machine learning framework is generated using part of an ordered sequence of event encoding data objects. In some embodiments, at least one event encoding data object in an ordered sequence of event encoding data objects that is supplied used to train the machine learning framework is provided at least twice to the machine learning framework.

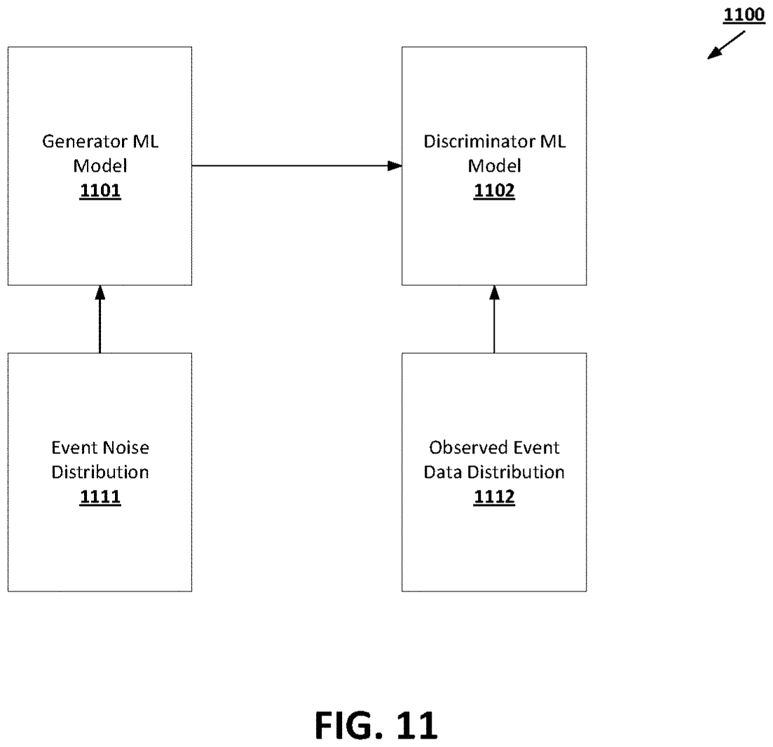

In some embodiments, the machine learning framework is a discriminator machine learning model, and the discriminator machine learning model is trained as part of a generative adversarial machine learning framework (e.g., a generative adversarial machine learning framework). An operational example of a generative adversarial machine learning framework 1100 is depicted in FIG. 11. As depicted in FIG. 11, the generative adversarial machine learning framework 1100 comprises: (i) a generator machine learning model 1101 that is configured to generate event noise data objects based at least in part on an event noise distribution 1111, and (ii) a discriminator machine learning model 1102 that is configured to process event noise data objects and observed event data objects sampled from an observed event data distribution 1112 to detect, for each processed event data object, an inferred conformance score describing whether the discriminator machine learning model 1102 predicts that the processed event data object is an observed event data object (rather than a noise event data object that is not sampled from observed data and is manufactured based at least in part on event noise data by the generator machine learning model 1101).

In some embodiments, training a generative adversarial machine learning framework includes performing the operations of the Equation 10 provided below:

$${min}_{G} {max}_{D} V ( D , G ) = {E}_{x \sim {p}_{d a t a} ( x )} [ log D ( {x}^{( i )} ) ] + {E}_{Z \sim {p}_{z} ( Z )} [ log ( 1 - D ( G ( z ) ) ) ] \qquad Equation 10$$

In Equation 10, p_{z}(Z) is the event noise distribution, G(z) is the set of event noise data objects (i.e., the output of the generator machine learning model sampling event noise data objects from the event noise distribution), D(G(z)) is the inferred conformance score generated by the discriminator machine learning model based at least in part on the event noise data objects, and D(x⁽ⁱ⁾) is the inferred conformance score generated by the discriminator machine learning model based at least in part on the observed event data objects.

In some embodiments, generating the generative adversarial machine learning framework comprises: generating the discriminator machine learning model, and generating a generator machine learning model of the generative adversarial machine learning framework. In some embodiments, generating the discriminator machine learning model comprises: identifying a defined number of event noise data objects; identifying a defined number of observed event encoding data objects based at least in part on an observed event distribution; processing each event noise data object using the discriminator machine learning model to generate a set of event noise inferences; processing each observed event encoding data object using the discriminator machine learning model to generate a set of observed event inferences; generating a discriminator gradient value for the discriminator machine learning model based at least in part on the set of event noise inferences and the set of observed event inferences; and updating one or more parameters of the discriminator machine learning model to maximize the discriminator gradient value. In some embodiments, generating the discriminator machine learning model comprises performing the operations of the below Equation 11:

$${∇}_{{θ}_{d}} \frac{1}{m} {\sum }_{i = 1}^{m} [ log D ( {x}^{( i )} ) + log ( 1 - D ( G ( {z}^{i} ) ) ) ] \qquad Equation 11$$

In Equation 11, G(zⁱ) is the defined number of (i.e., m) event noise data objects (i.e., the output of the generator machine learning model sampling event noise data objects from the event noise distribution), x¹, x², . . . x^{m} are the defined number of (i.e., m) observed event data objects, D (G(zⁱ)) is the inferred conformance score generated by the discriminator machine learning model based at least in part on the event noise data objects, D(x⁽ⁱ⁾) is the inferred conformance score generated by the discriminator machine learning model based at least in part on the observed event data objects, and θ_{d} are the parameters of the discriminator machine learning model.

In some embodiments, generating the discriminator machine learning model comprises identifying a defined number of event noise data objects; processing each event noise data object using the discriminator machine learning model to generate a set of event noise inferences; generating a generator gradient value for the generator machine learning model based at least in part on the set of observed event inferences; and updating one or more parameters of the generator machine learning model to minimize the generator gradient value. In some embodiments, generating the discriminator machine learning model comprises performing the operations of the below Equation 12:

$${∇}_{{θ}_{g}} \frac{1}{m} {\sum }_{i = 1}^{m} log ( 1 - D ( G ( {z}^{i} ) ) ) \qquad Equation 12$$

In Equation 12, G(zⁱ) is the defined number of (i.e., m) event noise data objects (i.e., the output of the generator machine learning model sampling event noise data objects from the event noise distribution), x¹, x², . . . x^{m} are the defined number of (i.e., m) observed event data objects, D (G(zⁱ)) is the inferred conformance score generated by the discriminator machine learning model based at least in part on the event noise data objects, and θ_{g} are the parameters of the generator machine learning model.

In some embodiments, generating the generative adversarial machine learning framework includes performing operations of the Algorithm 1 depicted below.

Algorithm 1

```
for number of training iterations do
  for k steps do
    • Sample minibatch of m noise samples {z⁽¹⁾ , . . . , z^{(m)}} from the
    noise prior p₀(z).
    • Sample minibatch of m samples {x⁽¹⁾ , . . . , x^{(m)}} from data
    generating distribution p_{data}(x).
    • Update the discriminator by ascending its stochastic gradient:
${∇}_{{θ}_{d}} \frac{1}{m} {\sum }_{i = 1}^{m} [ log D ( {x}^{( i )} ) + log ( 1 - D ( G ( {z}^{i} ) ) ) ]$
  end for
  • Sample minibatch of m noise samples {z⁽¹⁾ , . . . , z^{(m)}} from the
  noise prior p₀(z).
  • Update the generator by descending its stochastic gradient descent
${∇}_{{θ}_{g}} \frac{1}{m} {\sum }_{i = 1}^{m} log ( 1 - D ( G ( {z}^{i} ) ) )$
end for
```

### VI. CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method for determining a conformance score for a current event encoding data object of an ordered sequence of event encoding data objects, the computer-implemented method comprising:
for each encoding event data object, generating, using one or more processors and a machine learning framework, a state-level attention weight value and an attribute-level attention weight vector, wherein:
the machine learning framework comprises a state processing recurrent neural network machine learning model and an attribute processing machine learning model,
the state processing recurrent neural network machine learning model is configured to generate the state-level attention weight value for the event encoding data object based at least in part on each event encoding data object, and
the attribute processing machine learning model is configured to generate the attribute-level attention weight vector for the event encoding data object based at least in part on each event encoding data object;
generating, using the one or more processors, the conformance score based at least in part on: (i) each state-level attention weight value for a current subset of the ordered sequence that comprises the current event encoding data object and each event encoding data object that has a lower position value relative to the current event encoding data object in accordance with the ordered sequence, and (ii) each attribute-level attention weight vector for the current subset; and
performing, using the one or more processors, one or more prediction-based actions based at least in part on the conformance score.

2. The computer-implemented method of claim 1, wherein each event encoding data object comprises an event state encoding and an event attribute feature encoding characterized by one or more event attribute features.

3. The computer-implemented method of claim 2, wherein each attribute-level attention weight vector comprises an attribute-level attention weight value for each event attribute feature of the one or more event attribute features.

4. The computer-implemented method of claim 1, wherein the state processing recurrent neural network machine learning model is a long short term memory machine learning model.

5. The computer-implemented method of claim 1, wherein the attribute processing recurrent neural network machine learning model is a long short term memory machine learning model.

6. The computer-implemented method of claim 1, wherein:
the machine learning framework is a discriminator machine learning model, and
the discriminator machine learning model is trained as part of a generative adversarial machine learning framework.

7. The computer-implemented method of claim 6, wherein training the generative adversarial machine learning framework comprises:
generating, using the one or more processors, the discriminator machine learning model, and
generating, using the one or more processors, a generator machine learning model of the generative adversarial machine learning framework.

8. The computer-implemented method of claim 7, wherein generating the discriminator machine learning model comprises:
identifying a defined number of event noise data objects;
identifying a defined number of observed event encoding data objects based at least in part on an observed event distribution;
generating, using the discriminator machine learning model, a set of event noise inferences based at least in part on each event noise data object;
generating, using the discriminator machine learning model, a set of observed event inferences based at least in part on each observed event encoding data object;
generating a discriminator gradient value for the discriminator machine learning model based at least in part on the set of event noise inferences and the set of observed event inferences; and
updating one or more parameters of the discriminator machine learning model to maximize the discriminator gradient value.

9. The computer-implemented method of claim 7, wherein generating the discriminator machine learning model comprises:
identifying a defined number of event noise data objects;
processing each event noise data object using the discriminator machine learning model to generate a set of event noise inferences;
generating a generator gradient value for the generator machine learning model based at least in part on the set of observed event inferences; and
updating one or more parameters of the generator machine learning model to minimize the generator gradient value.

10. The computer-implemented method of claim 1, further comprising:
determining, using the one or more processors and for a kth event attribute feature of the one or more event attribute features of a jth event encoding data object in the ordered sequence and with respect to the conformance score for the jth event encoding data object, an attribute-level in-state contribution score based at least in part on the state-level attention weight value for the jth event encoding data object, the attribute-level attention weight vector for the jth event encoding data object, one or more trained parameters, and the and a target value of the jth event encoding data object that corresponds to the kth event attribute feature.

11. The computer-implemented method of claim 10, wherein performing the one or more prediction-based actions comprises:
generating user interface data for a prediction output user interface that depicts each attribute-level in-state contribution score for the jth event encoding data object.

12. The computer-implemented method of claim 1, wherein performing the one or more prediction-based actions comprises:
generating user interface data for a prediction output user interface that depicts the conformance score for each event encoding data object in the ordered sequence.

13. The computer-implemented method of claim 1, wherein performing the one or more prediction-based actions comprises:
generating user interface data for a prediction output user interface that depicts the state-level attention weight value for each event encoding data object in the ordered sequence.

14. An apparatus for determining a conformance score for a current event encoding data object of an ordered sequence of event encoding data objects, the apparatus comprising at least one processor and at least one memory including program code, the at least one memory and the program code configured to, with the processor, cause the apparatus to at least:
for each event encoding data object, generate, using a machine learning framework, a state-level attention weight value and an attribute-level attention weight vector, wherein:
the machine learning framework comprises a state processing recurrent neural network machine learning model and an attribute processing machine learning model,
the state processing recurrent neural network machine learning model is configured to generate the state-level attention weight value for the event encoding data object based at least in part on each event encoding data object, and
the attribute processing machine learning model is configured to generate the attribute-level attention weight vector for the event encoding data object based at least in part on each event encoding data object;
generate the conformance score based at least in part on: (i) each state-level attention weight value for a current subset of the ordered sequence that comprises the current event encoding data object and each event encoding data object that has a lower position value relative to the current event encoding data object in accordance with the ordered sequence, and (ii) each attribute-level attention weight vector for the current subset; and
perform one or more prediction-based actions based at least in part on the conformance score.

15. The apparatus of claim 14, wherein:
the machine learning framework is a discriminator machine learning model, and
the discriminator machine learning model is trained as part of a generative adversarial machine learning framework.

16. The apparatus of claim 15, wherein training the generative adversarial machine learning framework comprises:
generating the discriminator machine learning model, and
generating a generator machine learning model of the generative adversarial machine learning framework.

17. The apparatus of claim 16, wherein generating the discriminator machine learning model comprises:
identifying a defined number of event noise data objects;
identifying a defined number of observed event encoding data objects based at least in part on an observed event distribution;
generate, using the discriminator machine learning model, a set of event noise inferences based at least in part on each event noise data object;
generate, using the discriminator machine learning model, a set of observed event inferences based at least in part on each observed event encoding data object;
generating a discriminator gradient value for the discriminator machine learning model based at least in part on the set of event noise inferences and the set of observed event inferences; and
updating one or more parameters of the discriminator machine learning model to maximize the discriminator gradient value.

18. The apparatus of claim 16, wherein generating the discriminator machine learning model comprises:
identifying a defined number of event noise data objects;
processing each event noise data object using the discriminator machine learning model to generate a set of event noise inferences;
generating a generator gradient value for the generator machine learning model based at least in part on the set of observed event inferences; and
updating one or more parameters of the generator machine learning model to minimize the generator gradient value.

19. The apparatus of claim 14, further comprising:
determining, for a kth event attribute feature of the one or more event attribute features of a jth event encoding data object in the ordered sequence and with respect to the conformance score for the jth event encoding data object, an attribute-level in-state contribution score based at least in part on the state-level attention weight value for the jth event encoding data object, the attribute-level attention weight vector for the jth event encoding data object, one or more trained parameters, and the and a target value of the jth event encoding data object that corresponds to the kth event attribute feature.

20. A computer program product for determining a conformance score for a current event encoding data object of an ordered sequence of event encoding data objects, the computer program product comprising at least one non-transitory computer-readable storage medium having computer-readable program code portions stored therein, the computer-readable program code portions configured to:
for each event encoding data object, generate, using a machine learning framework, a state-level attention weight value and an attribute-level attention weight vector, wherein:
the machine learning framework comprises a state processing recurrent neural network machine learning model and an attribute processing machine learning model,
the state processing recurrent neural network machine learning model is configured to generate the state-level attention weight value for the event encoding data object based at least in part on each event encoding data object, and
the attribute processing machine learning model is configured to generate the attribute-level attention weight vector for the event encoding data object based at least in part on each event encoding data object;
generate the conformance score based at least in part on: (i) each state-level attention weight value for a current subset of the ordered sequence that comprises the current event encoding data object and each event encoding data object that has a lower position value relative to the current event encoding data object in accordance with the ordered sequence, and (ii) each attribute-level attention weight vector for the current subset; and
perform one or more prediction-based actions based at least in part on the conformance score.
